(19) United States
(12) Patent Application Publication
(10) Pub. No.: US 2009/0201599 A1
(43) Pub. Date: Aug. 13, 2009

(54) RECORDER AND RECORDING METHOD

(75) Inventor: Junichi KANENAGA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SONY CORPORATION, Tokyo (JP)

(21) Appl. No.: 12/347,019

(22) Filed: Dec. 31, 2008

(30) Foreign Application Priority Data
Feb. 7, 2008 (JP) 2008-027497

(51) Int. Cl. G11B 5/02

(52) U.S. Cl. 360/55; G9B/5.026

(57) ABSTRACT

A recorder of the present invention includes an optical disk drive section recording data on an optical disk, and a host section transferring data recorded on an arbitrary recording medium to the optical disk drive section to record the data on the optical disk, wherein the optical disk drive section intermittently records the data transferred from the host section on the optical disk.

### CROSS REFERENCES TO RELATED APPLICATIONS

The present invention contains subject matter related to Japanese Patent Application JP 2008-027497 filed in the Japan Patent Office on Feb. 7, 2008, the entire contents of which being incorporated herein by reference.

### BACKGROUND OF THE INVENTION

1. Field of the Invention

The present invention relates to a recorder, and a recording method.

2. Description of the Related Art

Devices such as a hard disk drive and an optical disk drive are known as a recorder/reproducer using a disk recording medium. In recent years, in addition to being used by being connected to a personal computer or the like, these recorder/reproducers devices are often being used as a recorder such as a video recorder, a video camera or the like. Particularly, when being used as a video camera recorder, since the device is a portable device, it becomes important that it operates with low electric power consumption to ensure long battery duration.

As a method for realizing low electric power consumption, an intermittent drive control is implemented, which suspends operation of a device for a predetermined period according to the data accumulation amount in a buffer memory. To perform the intermittent drive control, there has to be sufficient difference between the transfer rate of data to be recorded/reproduced and the speed of recording the data on and reproducing the data from the disk recording medium.

Accordingly, for example, in a case of real-time recording/reproduction where shot image data is being recorded in real time, the intermittent drive control is enabled by setting the data transfer rate sufficiently lower than the disk recording/reproducing speed. With such a control, it is made possible to lower electric power consumption, and also, to suppress the temperature rise in the housing of a device.

Further, JP-A-2003-281733 discloses a method of, in a real-time video processing and a finalizing processing using an optical disk, detecting the temperature within a device, and when the temperature rises above a predetermined level, suspending the operation of the disk device by stopping data transfer, and performing intermittent recording.

### SUMMARY OF THE INVENTION

However, the method of JP-A-2003-281733 described above does not take into consideration a situation where the data transfer rate and the recording speed become equal, such as in a case where data is transferred to a disk recording medium from another recording medium, such as a hard disk, a memory stick or the like. Thus, in such a situation, if the recording continues for a long time, there is particularly a problem that the temperature within the housing of a device rises, and also, that the life of a battery shortens due to the increase in electric power consumption.

Particularly, in recent years, for a recorder such as a portable video camera or the like, for example, there is a recorder in which an optical disk drive and a drive of another recording media such as a hard disk, a memory stick or the like are installed. In such a device, when transferring data between different recording media, read-out speed and write-in speed for data become equal resulting in a continuous recording. In such a case, there is a problem that electric power consumption increases due to the continuous recording, and also, that the temperature within the housing of the device rises. Particularly, in a downsized housing, the temperature may rise drastically causing an interference with the normal operation of the device.

Thus, in view of the foregoing, it is desirable to provide a new and improved recorder and a recording method capable of suppressing the temperature rise in a device, and also, of lowering electric power consumption at the time of transferring data recorded on a recording medium and recording the same.

According to an embodiment of the present invention, there is provided a recorder including a disk recording section recording data on a disk recording medium, and a host section transferring data recorded on an arbitrary recording medium to the disk recording section to record the data on the disk recording medium, wherein the disk recording section intermittently records the data transferred from the host section on the disk recording medium.

According to the configuration described above, data is recorded by a disk recording section on the disk recording medium, and data recorded on an arbitrary recording medium is transferred by a host section to the disk recording section to be recorded on the disk recording medium. Then, the data transferred from the host section is intermittently recorded on the disk recording medium. Accordingly, even if the transfer rate of the host section and the recording rate of the disk recording section are comparatively close to each other, it becomes possible to perform intermittent recording, and it becomes possible to suppress the temperature rise in the device, and also, reduce electric power consumption.

The disk recording section may include a transfer completion notification transmission section transmitting, after data transfer to the disk recording section is completed, a transfer completion notification to the host section after a predetermined delay time has passed, and the host section may transfer, after receiving the transfer completion notification, next data to the disk recording section. According to such a configuration, since, after data transfer to the disk recording section is completed, a transfer completion notification is transmitted to the host section after a predetermined delay time has passed, and next data is transferred after the transfer completion notification is received, it becomes possible for the disk recording section to restrict reception of transfer data, and thus, intermittent recording can be surely performed.

The transfer completion notification transmission section may vary the delay time according to data transfer speed or data transfer amount from the host section to the disk recording section. Accordingly to such a configuration, since the delay time varies according to the data transfer speed or data transfer amount, an effective transfer rate can be set according to the data transfer speed or the data transfer amount.

The host section may transfer data recorded on a plurality of recording media to the disk recording section, and the transfer completion notification transmission section may vary the delay time according to the type of each recording medium. According to such a configuration, transfer rate from the host section to the disk recording section may be set according to the transfer rate of each recording medium.

According to another embodiment of the present invention, there is provided a recording method recording data recorded on an arbitrary recording medium on a disk recording medium, including the steps of transferring the data to the disk recording medium, issuing, after recording the data on the disk recording medium, a transfer completion notification after a predetermined delay time has passed, and transferring, upon issuance of the transfer completion notification, next data to the disk recording medium.

According to the configuration described above, in the method of recording data recorded on an arbitrary recording medium on a disk recording medium, data recorded on an arbitrary medium is transferred to the disk recording medium, and after the data is recorded on the disk recording medium, a transfer completion notification is issued after a predetermined delay time has passed, and, on the issuance of the transfer completion notification, next data is transferred to the disk recording medium. Accordingly, it becomes possible to restrict reception of transfer data by the disk recording medium, and even when the transfer rate and the recording rate on the disk recording medium are comparatively close to each other, it becomes possible to perform intermittent recording. Thereby, it becomes possible to suppress the temperature rise in the device, and also, reduce electric power consumption.

According to the present invention, it becomes possible to suppress the temperature rise in a device, and also, reduce electric power consumption at the time of transferring data recorded on a recording medium and recording the same.

### BRIEF DESCRIPTION OF THE DRAWINGS

FIG. 1 is a block diagram showing a configuration of a recorder/reproducer according to an embodiment of the present invention.

FIG. 2 is a characteristics diagram showing a relation between data amount and time at the time of non real-time recording.

FIG. 3 is a schematic diagram explaining a method of an optical disk drive section restricting reception of data from a host section.

FIG. 4 is a schematic diagram explaining a method of an optical disk drive section restricting reception of data from a host section.

FIGS. 5A and 5B are schematic diagrams showing cases where data is transferred to a host section from a recording medium with comparatively slow transfer speed.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

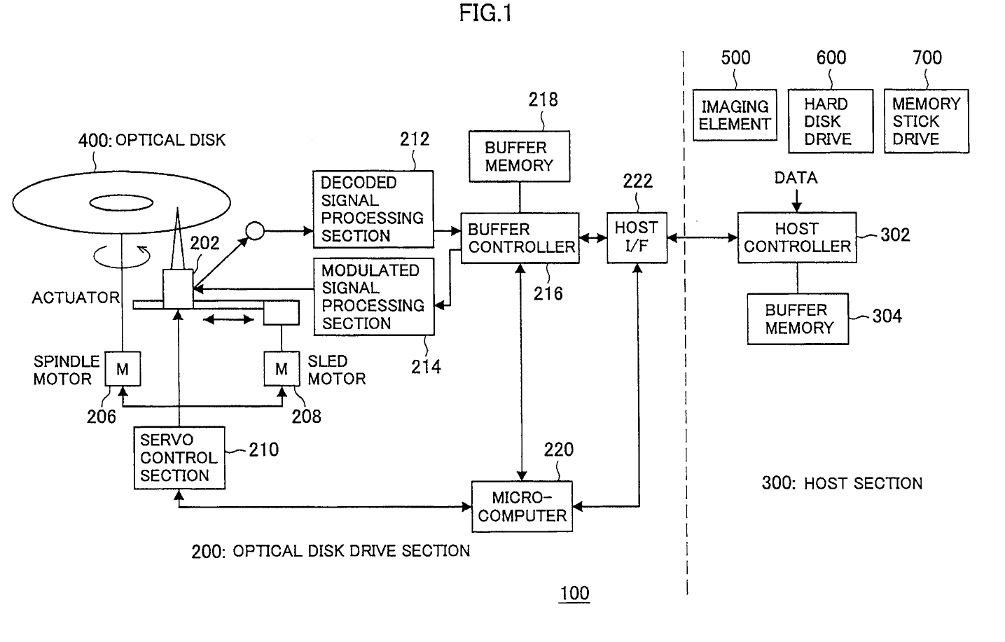

FIG. 1 is a block diagram showing a configuration of a recorder/reproducer 100 according to an embodiment of the present invention. The recorder/reproducer 100 is a device such as a camcorder recording a picked up image, for example, and as shown in FIG. 1, includes an optical disk drive section 200 and a host section 300. The optical disk drive section 200 writes (records) data on an optical disk 400, and reads (reproduces) data on the optical disk 400. Further, the recorder/reproducer 100 includes an imaging element 500, and an optical system (not shown) for forming a subject image on the imaging area of the imaging element 500. Further, the recorder/reproducer 100 includes drives of various recording media, such as a hard disk drive 600, a memory stick drive 700 and the like for recording image data.

The optical disk drive section 200 includes an optical pick-up 202, a spindle motor 206, a sled motor 208, a servo control section 210, a decoded signal processing section 212, a modulated signal processing section 214, a buffer controller 216, a buffer memory 218, a micro-computer 220, and a host interface (host I/F) 222.

When recording data, the record data is transmitted to the modulated signal processing section 214. The modulated signal processing section 214 modulates the record data at the time of recording the data on the optical disk 400. For example, in case of a Blu-ray disk, 17 modulation is performed sequentially. Laser is modulated according to these modulated data, and with the optical pick-up 202 irradiating the laser, the data is recorded on the optical disk 400.

Further, when reproducing data, first, a light intensity signal (RF signal) corresponding to the record data is read out by the optical pick-up 202. The signal read out is digitized by the decoded signal processing section 212 after being waveform-shaped, and is converted to digital data 0/1. The digitized signal is accumulated in the buffer memory 218 by the buffer controller 216.

The micro-computer 220 gives a control signal to the servo control section 210. The spindle motor 206 driving the optical disk 400, the sled motor 208 controlling tracking, an actuator controlling the position of the optical pick-up 202 in relation to the optical disk 400, and the like, are controlled by the servo control section 210. Accordingly, being controlled by the micro-computer 220, the optical disk drive section 200 can write data on a desired position on the optical disk 400, and read data on a desired position on the optical disk 400 to reproduce the data. Further, the micro-computer 220 transmits a control signal to the buffer controller 216, and controls transmission/reception of data within the buffer memory 218.

The host section 300 includes a host controller 302 and a buffer memory 304. Data, such as image data or the like, is transmitted to the host controller 302 from the imaging element 500, the hard disk drive 600 or the memory stick drive 700. The host controller 302 performs control at the time of transferring the data transmitted from the drive 600 or 700 to the optical disk drive section 200.

The host interface 222 of the optical disk drive section 200 and the host controller 302 of the host section 300 are connected via, for example, an ATA interface. The data transmitted from the imaging element 500, the drive 600 or 700, or the like, as described above, is accumulated in the buffer memory 304 by the host controller 302 as appropriate. Further, the data transmitted from the imaging element 500, the drive 600 or 700 is transmitted to the optical disk drive section 200 by the host controller 302 to be recorded in the optical disk 400. The data transmitted to the optical disk drive section 200 is stored in the buffer memory 218 as appropriate, and recorded in the optical disk 400 according to the control by the micro-computer 220.

The micro-computer 220 controls recording and stop of recording on the optical disk 400 according to the amount of remaining space in the buffer memory 218 of the optical disk drive section 200. Further, the micro-computer 220 controls recording and stop of recording on the optical disk 400 by transmitting a transfer completion notification described later to the host controller 302. When the amount of free space in the buffer memory 218 decreases or becomes 0, the micro-computer 220 stops the recording operation, and then, immediately brings the servo control section 210 and the modulated signal processing section 214 to a halt state, thereby performing control so as to reduce the electric power consumption of the recorder/reproducer 100.

When recording data shot by the imaging element 500 on the optical 400 in real time (at the time of real-time recording), the recording speed of the optical disk drive section 200 is sufficiently high relative to the rate of the host section 300 receiving data from the imaging element 500. Thus, by recording intermittently, the optical disk drive section 200 reduces the electric power consumption. Specifically, the host controller 302 receives data from the imaging element 500 at a constant speed at all times, and until a certain amount of data is accumulated in the buffer memory 304, does not transfer data to the optical disk drive section 200. When a predetermined amount of data is accumulated in the buffer memory 304, the host controller 302 starts transferring the data to the optical disk drive section 200, and the optical disk drive section 200 records the received data on the optical disk 400. At this time, since the recording rate on the optical disk 400 is high, the optical disk drive section 200 can complete the recording of the received data faster than the speed of the host section 300 receiving data, and thus, it becomes possible to ensure a period where the recording operation is suspended.

Aside from the real-time recording described above, the recorder/reproducer 100 can transfer data recorded on the drive 600 or 700 to the optical disk drive section 200, and record the data on the optical disk 400 (non real-time recording). In this case, the rate of the host section 300 receiving data from the drive 600 or 700 is higher than the speed of the host section 300 receiving data from the imaging element 500. Thus, the speed of the host section 300 receiving data from the drive 600 or 700 and the recording speed of the optical disk drive section 200 become comparatively close to each other. Thus, at the time of non real-time recording, to prevent the buffer memory 218 from becoming saturated, data transmitted from the host section 300 may have to be recorded on the optical disk 400 in a continuous manner. Thus, due to the continuous recording, the temperature in the recorder/reproducer 100 rises and electric power consumption increases.

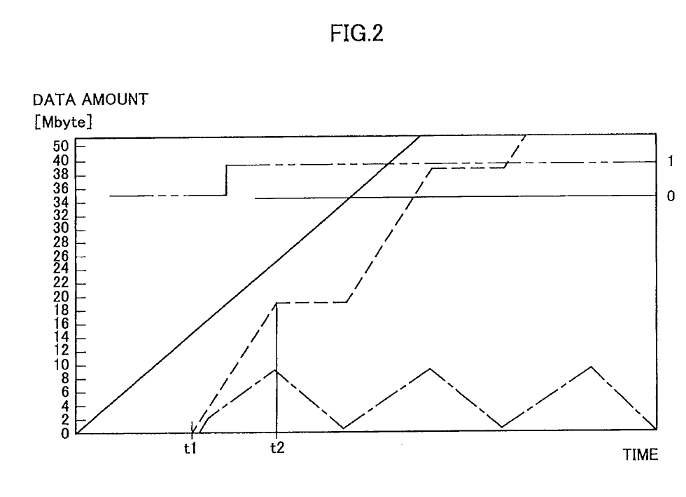

FIG. 2 is a characteristics diagram showing a relation between data amount and time at the time of non real-time recording, and the horizontal axis indicates time and the left side vertical axis of FIG. 2 indicates data amount (Mbyte). In FIG. 2, the characteristics shown with a solid line indicates the amount of data transmitted from the drive 600 or 700 to the host section 300. Also, the characteristics shown with a broken line indicates the amount of data transmitted from the host section 300 to the optical disk drive section 200. Also, the characteristics shown with a dashed-dotted line indicates the amount of data accumulated in the buffer memory 218.

Also, in FIG. 2, the characteristics shown with a dashed double-dotted line indicates whether recording is performed on the optical disk 400. When the value of the characteristics shown with the dashed double-dotted line is 0 on the right side vertical axis of FIG. 2, the recording on the optical disk 400 is not being performed, and when the value of the characteristics shown with the dashed double-dotted line is 1 on the right side vertical axis of FIG. 2, the recording on the optical disk 400 is being performed.

At the time of non real-time recording, as described above, the speed of the host section 300 receiving data and the recording speed of the optical disk drive section 200 become comparatively close to each other. Thereby, as shown in FIG. 2, the values of the gradient of the amount of data (solid line) transmitted from the drive 600 or 700 to the host section 300 and the gradient of the amount of data (broken line) transmitted from the host section 300 to the optical disk drive section 200 are comparatively close to each other. Accordingly, when the recording on the optical disk 400 is started immediately after time t1 at which point the data transfer from the host section 300 to the optical disk drive section 200 is started, after the data transfer from the host section 300 to the optical disk drive section 200 is temporarily stopped (time t2), the recording on the optical disk 400 continues to reduce the memory taken up in the buffer memory 218. Accordingly, as shown by the characteristics shown with the dashed double-dotted line in FIG. 2, at the time of non real-time recording, recording on the optical disk 400 is performed in a continuous manner.

Thus, in the present embodiment, in a case where recording and reproduction do not need to be performed in real time, such as in a case of transferring data from the drive 600 or 700 to the optical disk 400, with the optical disk drive section 200 restricting the reception of data, the data transfer rate from the host section 300 to the optical disk drive section 200 is controlled to be adequately low relative to the recording speed on the optical disk 400. Thereby, since the amount of data transmitted to the optical disk drive section 200 is restricted, it becomes possible to drive the optical disk drive section 200 in an intermittent manner, and to suppress the temperature rise and the increase in electric power consumption.

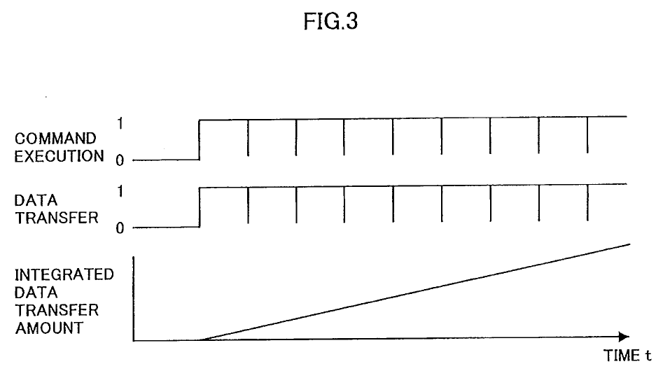

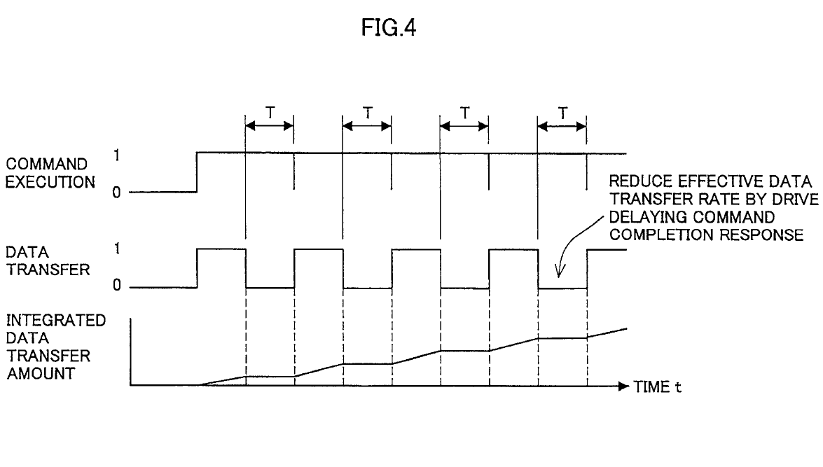

Hereunder, based on FIGS. 3, 4, 5A and 5B, a method of the optical disk drive section 200 restricting reception of data from the host section 300 will be described in detail. Here, FIGS. 3 and 4 show a signal waveform relating to execution of command transmitted from the micro-computer 220 to the host controller 302 (command execution), a signal waveform relating to execution of data transfer by the host controller 302 (data transfer), and the integrated value of the amount of data transferred from the host section 300 to the optical disk drive section 200, respectively. Also, FIG. 3 indicates a real-time recording, and FIG. 4 indicates a non real-time recording.

First, based on FIG. 3, a method of recording data on the optical disk 400 at the time of a real-time recording will be described. In FIG. 3, the signal waveform relating to command execution indicates a command requesting the host section 300 to transfer data to the optical disk drive section 200. This command is transmitted from the micro-computer 220 of the optical disk drive section 200 to the host controller 302 of the host section 300 via the host interface 222. Then, when the signal waveform relating to command execution becomes high “1”, the execution of data transfer is instructed to the host section 300. Further, when the signal waveform relating to command execution becomes low “0”, the host section 300 is notified that the data transfer is completed. Such signal waveform relating to command execution, which is set to low “0”, serves as a transfer completion notification to the host section 300.

The signal waveform relating to data transfer shown in FIG. 3 indicates a command for the execution of data transfer by the host controller 302 to the optical disk drive section 200. When the host controller 302 is instructed by the optical disk drive section 200 to execute a command, the signal waveform relating to data transfer in FIG. 3 becomes high, and data is transferred by the host controller 302 to the optical disk drive section 200.

As shown in FIG. 3, in the real-time recording, the signal waveform relating to command execution is set to low when one command is completed, and at the same time, it is set to high to execute next data transfer. Thereby, a continuous data transfer is performed, and data is written on the optical disk 400 in a continuous manner. Accordingly, as shown in FIG. 3, the integrated amount of data transfer linearly increases with time. Incidentally, in FIG. 2, a case where data is transferred to the optical disk drive section 200 in a continuous manner by the characteristics indicated by the dashed double-dotted line has been described for the sake of convenience. Here, the execution command for the transfer by the host controller 302 is issued, specifying a certain amount of transfer data, such as 32 Kbytes or 64 Kbytes, for example.

On the other hand, in the non real-time recording, as shown in FIG. 4, after a predetermined delay time T has passed after completion of one data transfer, the signal waveform relating to command execution is set to low by the micro-computer 220. Thereby, a data transfer completion notification is notified to the host controller 302 with the delay of time T from the completion of transfer. Thereby, after the completion of data transfer, data is not transferred from the host section 300 to the optical disk drive section 200 for a period of T until the signal waveform relating to command execution becomes low, and thus, it becomes possible for the optical disk drive section 200 to restrict reception of data. Thus, by sequentially recording data transferred intermittently, the optical disk drive section 200 can realize an intermittent recording on the optical disk 400. Such method of data transfer to an optical disk drive section and method of data recording by an optical disk drive section can be realized with the micro-computer 220 merely setting a delay time T, and the host section 300 needs no special configuration.

The signal waveform relating to command execution becomes high immediately after it became low, and as in the real-time recording, a command for next data transfer is sent out. Thereby, the next data is transferred according to the instruction from the host controller 302.

As such, with the optical disk drive section 200 restricting reception of data, as shown in FIG. 4, the data transfer integrated amount does not change during periods T. Accordingly, it becomes possible to reduce the effective transfer rate from the host section 300 to the optical disk drive section 200.

Accordingly, when dividing data to be transferred into certain segments and recording the same, with the optical disk drive section 200 delaying a response to a recording command, it becomes possible to restrict the effective data transfer rate. Thus, the optical disk drive section 200 can ensure an arbitrary suspension period (time T), and the optical disk drive section 200 can control the data transfer rate to be a desired level.

As a concrete method of delaying a response, for example, time T may be a fixed value set beforehand to suppress the temperature rise and the increase in electric power consumption. Also, the micro-computer 220 of the optical disk drive section 200 may measure the data transfer time taken by the host controller 302 to transfer data in response to one recording command, and based on the measured transfer time, delay time T of a response to the recording command can be controlled such that the data reception speed is of a ratio most effective for low electric power consumption. At this time, time T can be controlled according to the data transfer speed and the data transfer amount. The amount of recording on the optical disk 400 increases and continuous recording becomes necessary as the data transfer speed and the data transfer amount increase. Thus, it is desirable that time T is made longer as the data transfer speed and the data transfer amount increase. Thereby, intermittent recording can be surely performed.

Also, delay time T may be variable according to the type of the drive 600 or 700. Normally, the data transfer speed of a hard disk is higher than the data transfer speed of a memory stick, and thus, in a case of transferring data from the drive 600, time T is set to be longer than in a case of transferring data from the drive 700. Thus, even in a case where data is transferred from the hard disk drive 600 at a high transfer speed, the data transfer rate can be suppressed, and the temperature rise and the increase in electric power consumption can be suppressed.

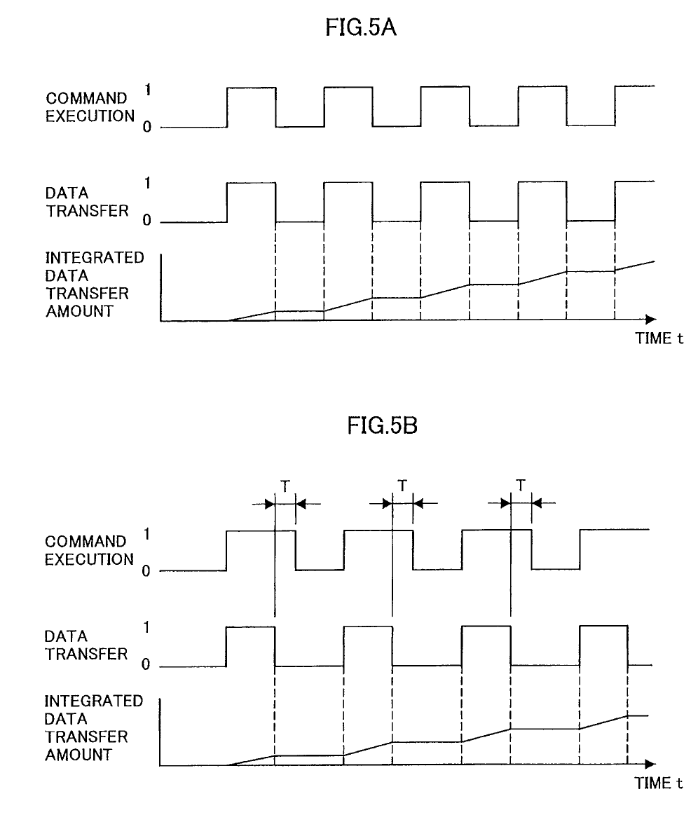

FIGS. 5A and 5B are schematic diagrams showing cases where data is transferred to the host section 300 from a recording medium with comparatively slow transfer speed. In this case, since the speed itself of the host section 300 receiving data is slow, even in a non real-time recording, as shown in FIG. 5A, data transfer from the host section 300 to the optical disk drive section 200 is performed intermittently.

FIG. 5A shows a case where delay time T is not provided. In this case, every time the signal waveform relating to command execution becomes high, data transfer is performed intermittently. Since data transfer is intermittent, the temperature does not easily rise, and also, electric power consumption can be suppressed.

To reduce data transfer speed more than in the case of FIG. 5A, as shown in FIG. 5B, delay time T is provided. Thus, although the interval of the signal waveform relating to command execution is the same as that of FIG. 5A, since the period during which data is not transferred is longer by time T, the effective data transfer speed may be reduced. As such, it is possible to insert delay time T only in a case where data transfer speed is high.

As described above, according to the present embodiment, after data transfer from the host section 300 to the optical disk drive section 200 is completed, by delaying the timing of transmission of a transfer completion notification from the optical disk drive section 200 to the host section 300, it becomes possible to reduce the effective rate of data transfer. Thus, it becomes possible to intermittently record data on the optical disk 400, and the temperature rise in the recorder/reproducer 100 due to continuous recording can be suppressed, and also, electric power consumption can be reduced.

It should be understood by those skilled in the art that various modifications, combinations, sub-combinations and alterations may occur depending on design requirements and other factors insofar as they are within the scope of the appended claims or the equivalents thereof.

For example, in the embodiment described above, an example is shown where transfer data is transmitted to the optical disk drive section 200. However, when recording the transfer data on a recording medium other than the optical disk 400, the same method may be used to reduce the transfer rate. Also, the transfer data transmitted by the host section 300 may be data transmitted from the imaging element 500 as well as data transmitted from other recording media, and the present embodiment can be broadly applied to cases where the data transfer rate and the recording rate at the time of recording are comparatively close to each other.

What is claimed is:

1. A recorder comprising:
a disk recording section recording data on a disk recording medium; and
a host section transferring data recorded on an arbitrary recording medium to the disk recording section to record the data on the disk recording medium, wherein
the disk recording section intermittently records the data transferred from the host section on the disk recording medium.

2. The recorder according to claim 1, wherein
the disk recording section includes a transfer completion notification transmission section transmitting, after data transfer to the disk recording section is completed, a transfer completion notification to the host section after a predetermined delay time has passed; and
the host section transfers, after receiving the transfer completion notification, next data to the disk recording section.

3. The recorder according to claim 2, comprising:
the transfer completion notification transmission section varies the delay time according to data transfer speed or data transfer amount from the host section to the disk recording section.

4. The recorder according to claim 2, wherein
the host section transfers data recorded on a plurality of recording media to the disk recording section, and
the transfer completion notification transmission section varies the delay time according to the type of each recording medium.

5. A recording method recording data recorded on an arbitrary recording medium on a disk recording medium, comprising the steps of:
transferring the data to the disk recording medium;
issuing, after recording the data on the disk recording medium, a transfer completion notification after a predetermined delay time has passed; and
transferring, upon issuance of the transfer completion notification, next data to the disk recording medium.
